(19) United States
(12) Patent Application Publication
(10) Pub. No.: US 2011/0257850 A1
(43) Pub. Date: Oct. 20, 2011

(54) VEHICLE ASSEMBLY CONTROL SYSTEM AND METHOD FOR COMPOSING OR DECOMPOSING A TASK

(76) Inventors: David R. Reeve, Chapel Hill (AU); Zille Eizad, Macgregor (AU); Andreas F. Ramm, Deception Bay (AU)

(21) Appl. No.: 12/760,363

(22) Filed: Apr. 14, 2010

(51) Int. Cl. G06F 19/00

(52) U.S. Cl. 701/50

(57) ABSTRACT

The present invention relates to a method for decomposing a task to be performed by at least one vehicle assembly. Initially, a higher-order information layer relating to the task and one or more rules for decomposing the higher-order information layer are provided. The method includes the step of decomposing, with a controller and at least partially, the higher-order information layer with the rules to form a lower-order information layer. The lower-order information layer relates to at least one subtask of the task. The present invention also relates to a method for composing the task.

### BACKGROUND OF THE INVENTION

1. Field of the Invention

The present invention relates to a method for decomposing a task to be performed by at least one vehicle assembly. The present invention has particular, although not exclusive, application to controllers for agricultural vehicle assemblies.

The present invention also relates to a method for composing a task to be performed by at least one vehicle assembly.

2. Description of the Related Art

The reference to any related art in this specification is not, and should not be taken as an acknowledgement or any form of suggestion that the related art qualifies as prior art or forms part of the common general knowledge.

Autonomous or driverless vehicles can perform tasks in hazardous environments and thereby reduce the possibility of operators becoming injured or even killed.

Some environments require multiple autonomous vehicles to operate in the same geographic area. Coordinating the vehicles to co-operate effectively is a difficult task, which can be further complicated as the number of vehicles and the amount of information required to control the vehicles increase.

### SUMMARY OF THE INVENTION

In the practice of an aspect of the present invention, a vehicle control system and method are provided for autonomous operation and control of an agricultural vehicle. One or more agricultural vehicles, such as a tractor pulling a sprayer, are provided with a control system for automatically controlling the direction and speed of the vehicle along a guide path, and operation of the sprayer for spraying swaths along the guide path.

A command center has a database including geographical location information relating to a field to be sprayed, and information relating to the task of spraying the field. The spraying task information includes a top-order field information layer having one or more field records identifying the task to be performed, the guide path end points, and the swath spray width. A middle-order guide path information layer is decomposed from the top-order field information layer using rules to create subtasks comprising the field to be sprayed broken down into multiple guide paths. A bottom order swath spray rate information layer is decomposed from the middle-order guide path information layer using rules to create swath spray rate records for each guide path.

The control system of each autonomous vehicle has a local version of the database for operation of the vehicle. The vehicle control system queries the database at the command center to receive a task, such as spraying along a guide path of a field according to the bottom-order swath spray rate information. The system and method provide for synchronization of the database and associated tasks among the command center and one or more autonomous agricultural vehicles to accomplish the task of spraying a field. Central control of the database by the command center, and queries by multiple autonomous spraying vehicles for spraying tasks, permit the system to deploy multiple driverless spraying vehicles that cooperate effectively for spraying a field.

The system further provides for a composition method for composing the task of spraying a field using an operator at the command center to input data into a database comprising geographical location information relating to a field to be sprayed, and information relating to the task of spraying the field.

### BRIEF DESCRIPTION OF THE DRAWINGS

Preferred features, embodiments and variations of the invention may be discerned from the following Detailed Description, which provides sufficient information for those skilled in the art to perform the invention. The Detailed Description is not to be regarded as limiting the scope of the Claims in any way. The Detailed Description will make reference to a number of drawings as follows:

FIG. 1 is a perspective view of a sprayer with a control system in accordance with an embodiment of the present invention;

FIG. 2 is a plan view of a field including sprayers of FIG. 1;

FIG. 3 is a block diagram cola control system for controlling the sprayer of FIG. 1;

FIG. 4 is a plan view of a portion of the field shown in FIG. 2;

FIG. 5 is a table of a database of the control system of FIG. 3;

FIG. 6 is a flowchart of a decomposition method performed by a controller of the control system of FIG. 3;

FIG. 7 is a flowchart of a composition method performed by a command center of FIG. 2; and

FIG. 8 is a block diagram of a control system at the command center of FIG. 2.

### DETAILED DESCRIPTION OF PREFERRED EMBODIMENTS

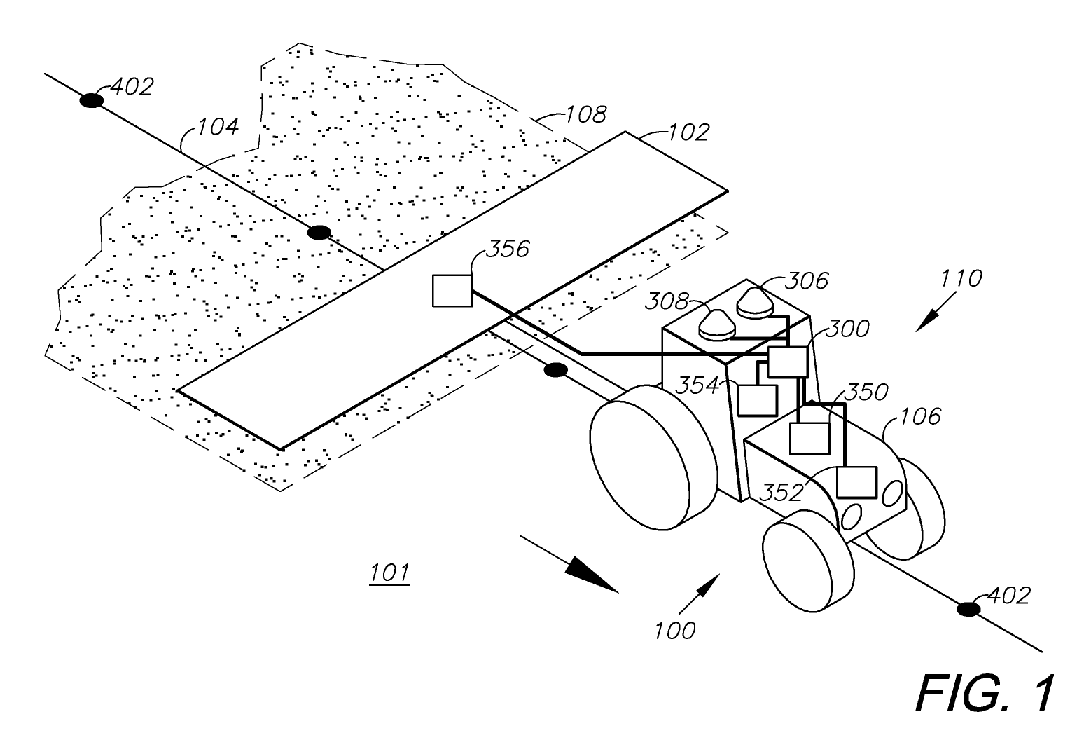

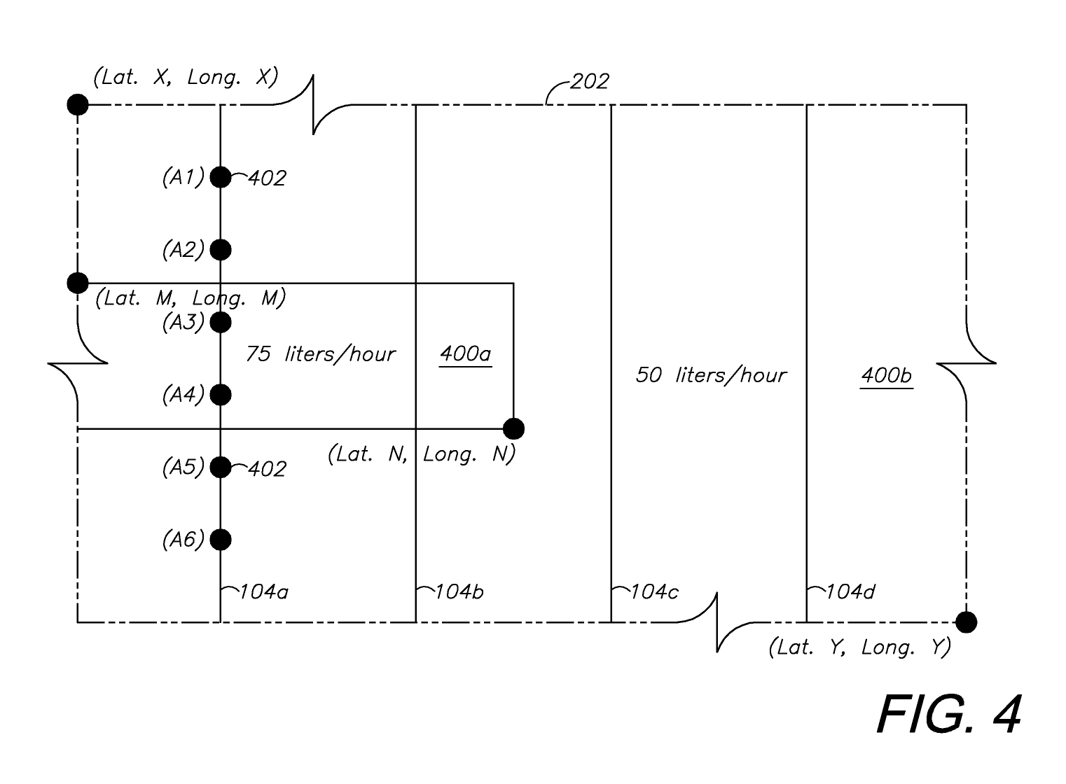

FIG. 1 shows a sprayer vehicle assembly 100 (hereinafter referred to as “sprayer”) for spraying a crop 101. The sprayer 100 includes a vehicle 106 which tracks along a guide path 104, and a spray unit 102 attached to the vehicle 106 for spraying a swath 108. A control system 110 is provided onboard the vehicle 106 for automatically controlling the position and operation of the sprayer 100 along waypoints 402 (FIG. 4) coincident with the guide path 104 during spraying. The control system 110 can automatically control the steering and speed of the vehicle 106, and also activates the spray unit 102. Related vehicle control systems are shown in U.S. Pat. No. 7,689,354 for Adaptive Guidance System and Method, issued Mar. 30, 2010, and U.S. Applications No. 61/243,417 for Vehicle Assembly Controller with Automaton Framework and Control Method and No. 61/243,475 for GNSS Integrated Multi-Sensor Control System and Method, both filed Sep. 17, 2009, all of which are assigned to a common assignee herewith and are incorporated herein by reference. Control systems and methods using multiple GNSS antennas and receivers on tractors and implements are disclosed in U.S. patent application Ser. No. 12/355,776 for Multi-Antenna GNSS Control System and Method, which is assigned to a common assignee herewith and is incorporated herein by reference.

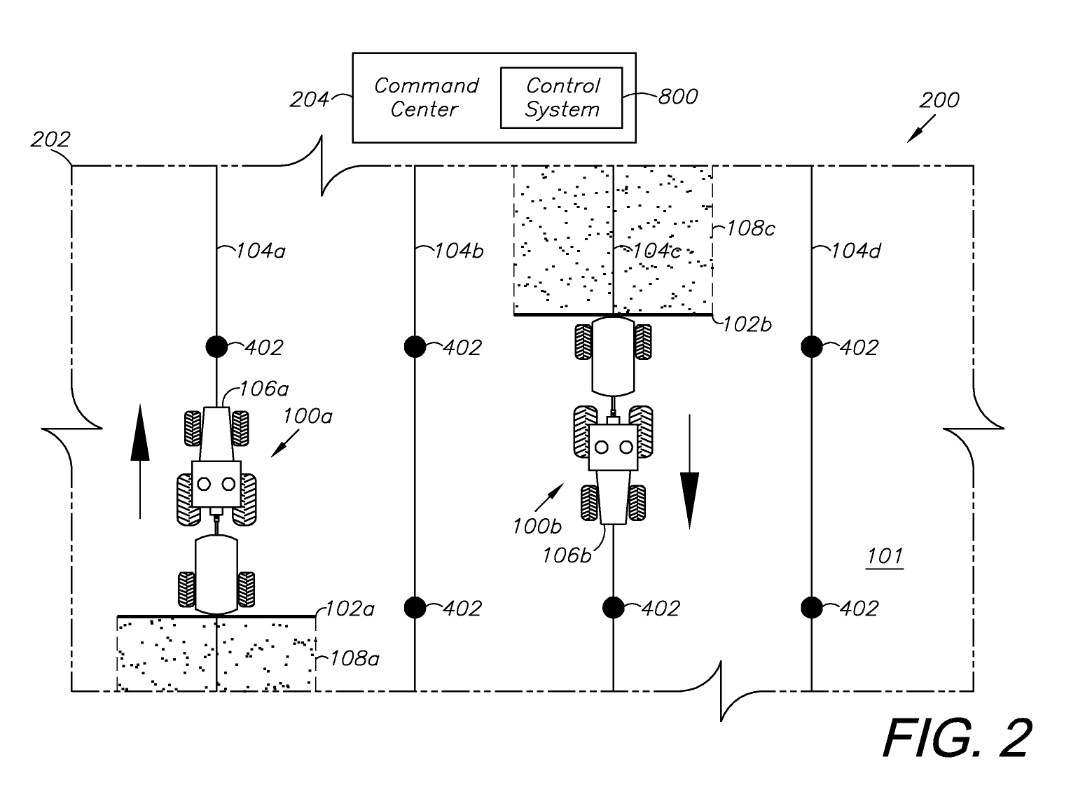

FIG. 2 shows a spraying system 200 for spraying a field 202. The spraying system 200 can include many like driverless, autonomous sprayers 100a, 100b, including vehicles 106a, 106b with spray units 102a, 102b respectively, which perform collaborative behavior to spray swaths (108a, 108c, FIG. 2) extending across the field 202. A command center 204 controls operation of the sprayers 100a, 100b and comprises a control system 800 including a database 804. The database 804 can include geographical location information relating to the field 202 and a top-order field information layer 500 relating to the task of spraying the field 202. The control system 800 composes the top-order field information layer 500 relating to the task of spraying the field 202, and places the top-order information layer 500 within the database 804. The database 804 is distributed, with mirrored local versions of the database 304 being located proximal to respective control systems 110 to improve information access speed. The sprayers 100a, 100b and the command center 204 directly access task information in their version of the database 304, 804 which can lead to discrepancies in information between each version. The local versions of the database 304 are periodically synchronized so that they generally include the same information as the database 804.

The sprayers 100 can access the database 304, which represents a “real world view” of the spraying system 200, and decompose the top-order field information layer 500 with rules to form a middle-order guide path information layer 502 and then a bottom-order swath spray rate information layer 504 of increasing memory space complexity and that relates to respective swath and spray rate subtasks of spraying the field 202. In this manner, each sprayer 100 need only decompose at least part of one or more higher-order layers when required, thereby minimizing overall memory space complexity for the spraying system 200. The sprayers 100 effectively act as automatons performing subtasks to collaboratively spray the field 202.

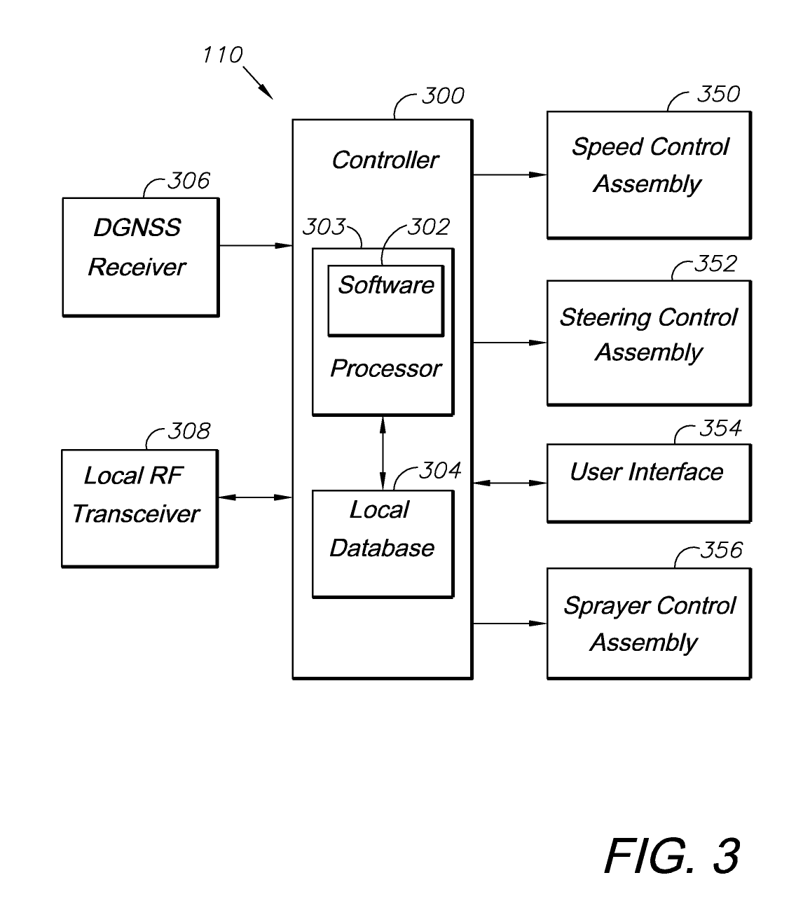

Turning to FIG. 3, each control system 110 includes a central controller 300 in which a software product 302 is contained in resident memory. In turn, the software product 302 contains computer readable instructions for execution by a processor 303 of the controller 300 to perform the decomposition method outlined below. The processor 303 is interfaced to a storage device including but not limited to, a hard disc containing a local version of the database 304 which includes, among other data relating to the control system 110, geographical location information relating to the field 202 being sprayed by the sprayers 100. In use, each controller 300 uses the database information to generate a path of waypoints 402 controlling the motion of the vehicle 106, as described in International Application No. PCT/AU2008/000002 for a Vehicle Control System, filed Jan. 2, 2008, which is assigned to a common assignee herewith and is incorporated herein by reference.

The processor 303 is electrically coupled to terminal ports for connecting to receiver 306, transceiver 308, actuator assemblies 350, 352 of the vehicle 106, a user interface 354 of the vehicle 106, and the spray unit 102.

Elaborating further, the control system 110 includes a differential global navigation satellite system (DGNSS) receiver 306 for sensing the location of the sprayer 100. Global navigation satellite systems (GNSSs) are broadly defined to include the Global Positioning System (GPS, U.S.), Galileo (Europe), GLONASS (Russia), Beidou (China), Compass (proposed), the Indian Regional Navigational Satellite System (IRNSS), QZSS (Japan, proposed) and other current and future positioning technology using signals from satellites, with or without augmentation from terrestrial sources. The receiver 306 receives location information relating to the vehicle 106 (and therefore the spray unit 102) which the controller 300 uses to determine the vehicle location and pose (i.e. attitude or orientation) that, in turn, is stored in the database 304. The controller 300 can also determine the speed of the vehicle 100 using this information.

A local radio frequency (RF) transceiver 308 transmits synchronisation information to, and receives synchronization information from, other local RF transceivers 308 of the sprayers 100 and the command center 204. As previously discussed, the synchronization information is used to update the local versions of the database 304 so that the versions all generally include the same information.

The control system 110 includes two driven-outputs in the form of vehicle speed control assembly 350 and vehicle steering control assembly 352. During automatic control of the vehicle 106, the controller 300 controls the vehicle speed control assembly 350 (including an accelerator of the vehicle 106) so that the vehicle 106 automatically travels at a desired speed along a guide path 104 or generated path of waypoints 402. At this time, the controller 300 can also control the vehicle steering control assembly 352 (including a steering valve block of the vehicle 106) so that the vehicle 106 is automatically steered.

The control system 110 further includes a user interface 354. The user interface includes a keyboard which enables an operator of the vehicle 106 to input information and commands. The user interface 354 also includes a display which displays information to the operator.

The control system 110 further includes a sprayer control assembly 356 for controlling the spraying of the swath 108 by the sprayer 102 with fertilizer, pesticide or other material as required. The spray unit 102 has a variable spray rate, which is based upon its geographic location and which is determined by the controller 300 on the field 202.

According to an embodiment of the present invention, there is provided a method for controlling the sprayers 100a, 100b using respective onboard controllers 300. The sprayers 100a, 100b bid for subtasks relating to spraying the field 202 as described in U.S. Application No. 61/265,281 for Vehicle Assembly Control Method for Collaborative Behavior, filed Nov. 30, 2009, which is which is assigned to a common assignee herewith and is incorporated herein by reference. A decomposition method 600 performed by each controller 300 is described in detail below.

FIG. 4 shows that the rectangular field 202 is defined by the geographical corner points (Lat X, Long X) and (Lat Y, Long Y). The field 202 includes an inner rectangular segment 400a defined by the geographical corner points (Lat M. Long M) and (Lat N, Long N) in which the required swath spray rate of the spray unit 102 is 75 litres/hour. The swath spray rate of the spray unit 102 in the remaining segment 400b of the field 202 is required to be 50 litres/hour. A guide path 104a is represented by a series of waypoints 402 each having a latitude (e.g. Lat A1) and longitude (e.g. Long A1).

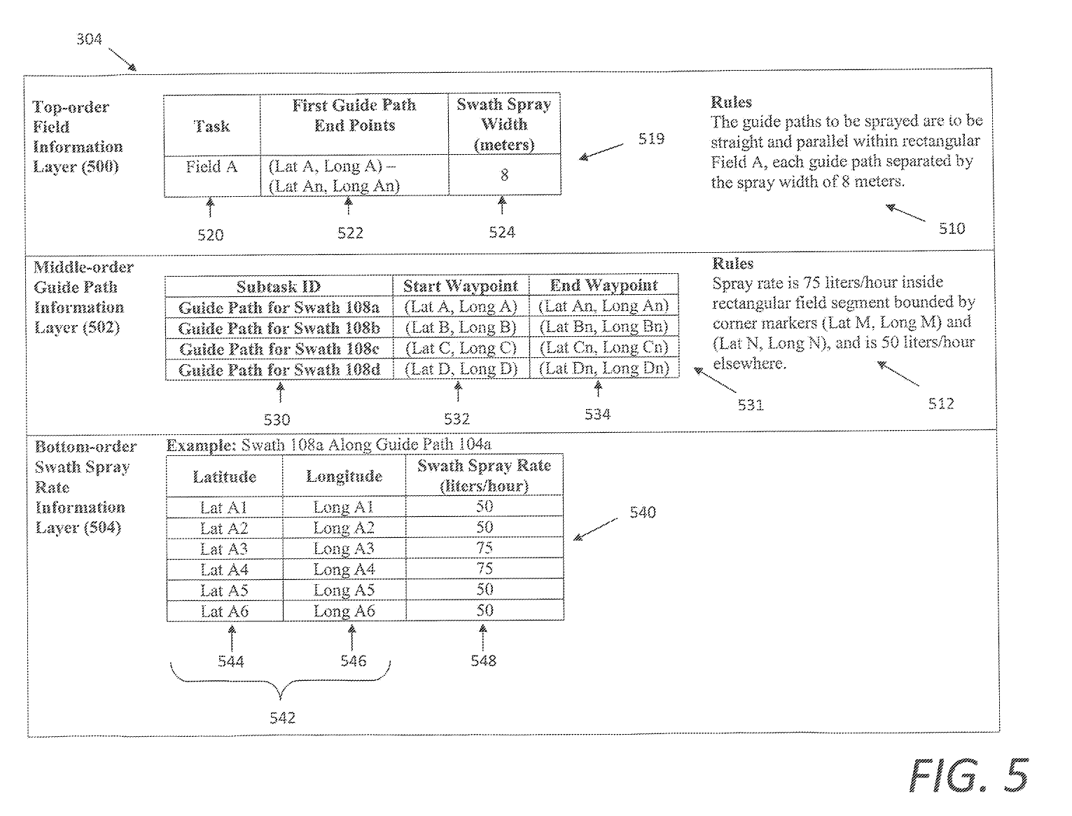

FIG. 5 shows that the databases 304, 803 include a top-order field information layer 500, a middle-order guide path information layer 502 and a bottom-order swath spray rate information layer 504, in order of increasing memory space complexity. The information layers 500, 502, 504 include spatial information relating to the field 202 in which the sprayer 100 can spray. The top-order field information layer 500 has associated top-order field rules 510 for decomposing the top-order field information layer 500 to form the middle-order guide path information layer 502. In addition, the middle-order guide path information layer 502 has associated middle-order guide path rules 512 for decomposing the middle-order guide path information layer 502 to form the bottom-order swath spray rate information layer 504.

The top-order field information layer 500 has one or more field records 519. Each field record 519 includes a task field 520 identifying a task to be performed in the form of spraying the field 202 (e.g. Field A), a first guide path endpoints field 522 which relates to the pair of endpoints of the first guide path 104a in the field 202, and a swath spray width field 524 which relates to the swath spray width (e.g. 8 meters) of each sprayer 100.

The top-order field rules 510 indicate that the guide paths 104 to be sprayed are to be straight and parallel within the rectangular field 202 identified in the task field 520, with each guide path 104 separated from its adjacent guide path 104 (starting with the first guide path defined in the first guide path endpoints field 522) by the swath spray width in the swath spray width field 524. A guide path layout including guide paths 104a to 104d decomposed by the controller 300 in accordance with these rules 510 is shown in FIG. 2.

The decomposed middle-order guide path information layer 502 includes a plurality of guide path records 531 relating to respective swaths 108 of the field 202. Each guide path record 531 includes a subtask field 530 identifying the guide path 104 and swath 108 of the field 202 to be sprayed, a start waypoint field 532 relating to the first waypoint in the guide path 104, and an end waypoint field 534 relating to the last waypoint in the guide path 104. The middle-order guide path information layer 502 relates to subtasks of spraying swaths 108 of the task of spraying the field 202.

The middle-order field rules 512 indicate that the swath spray rate is 75 litres/hour within the inner rectangular segment 400a of field 202 and is 50 litres/hour in the remaining segment 400b. A single guide path 104a (i.e. swath 108a) including waypoints 402 (A1-A6) decomposed by the controller 300 in accordance with these rules 512 is shown in the map of FIG. 4. Similarly, the other guide paths 104b-104d would be decomposed by the controller 300 if required.

The decomposed bottom-order swath spray rate information layer 504 includes a plurality of swath spray rate records 540 for either one or each swath 108 corresponding to a guide path record 531. Each swath spray rate record 540 includes a waypoint 542 defined by a waypoint latitude field 544 and a waypoint longitude field 546, and a swath spray rate field 548 (e.g. 75 litres/hour) or attribute associated with each waypoint 542 as determined in accordance with the middle-order field rules 512. The bottom-order swath spray rate information layer 504 relates to subtasks of setting spray rates at the waypoints 542 of the task of spraying the guide path 104.

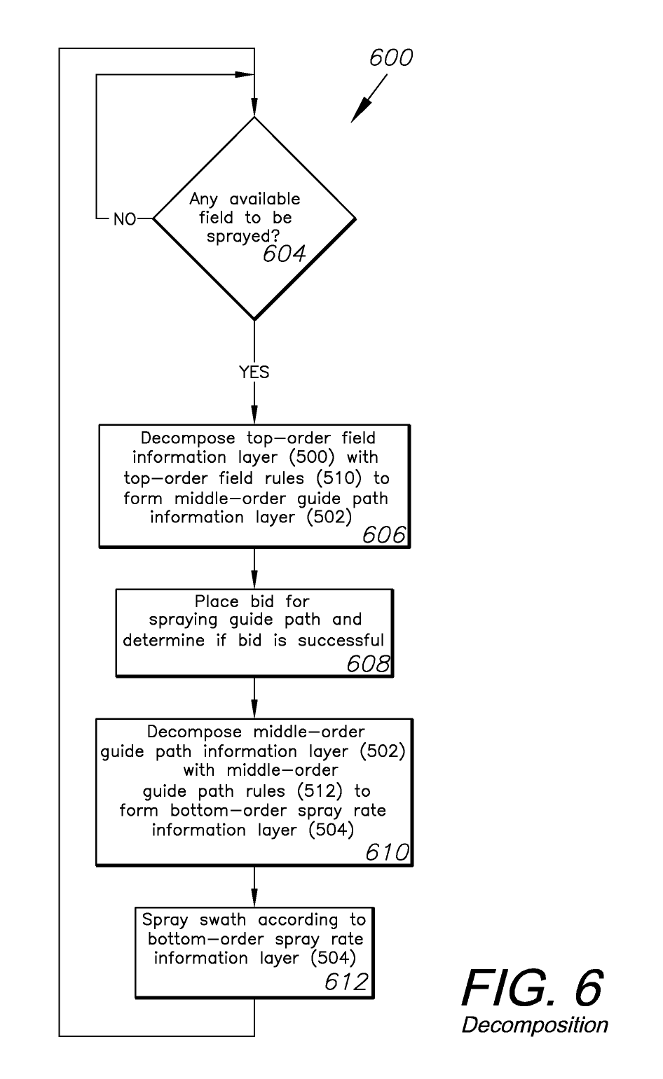

FIG. 6 shows the decomposition method 600 performed by each sprayer 100 using its controller 300 executing a computer program 302.

Initially, the sprayer 100 is looking for a field 202 to spray and may already be spraying a current swath 108. As previously explained, the command center 204 can at any time store in the database 804, one or more top-order field information layers 500 relating to fields 202 to be sprayed.

At query step 604, the sprayer controller 300 queries the command center 204 whether at least one top-order field information layer 500 is present in the database 804. If not, the controller 300 continues searching for a task to perform by polling at step 604. If the controller 300 determines a field 202 is to be sprayed at step 604, the method proceeds to step 606.

At step 606, the controller 300 decomposes the top-order field information layer 500 with the top-order field rules 510 to form the middle-order guide path information layer 502 of greater complexity, as shown in FIG. 5. The controller 300 displays task information to the sprayer operator on the user interface 354 based upon the spatial information in the middle-order guide path information layer 502. The displayed task information includes a map of the field 202 showing the guide paths 104 to be sprayed as shown in FIG. 2.

At step 608, the controller 300 places a bid for spraying along a guide path 104a (e.g. swath 108a) of the field 202 in accordance with spatial information in the middle-order guide path information layer 502. The controller 300 determines that the placed bid was successful when compared with bids of other vehicle sprayers 100.

At step 610, the controller 300 decomposes the guide path record 531 of the middle-order guide path information layer 502 (corresponding to the guide path 104a to be sprayed) with the middle-order guide path rules 512 to form the bottom-order swath spray rate information layer 504. The controller 300 displays task information to the sprayer operator on the user interface 354 based upon the spatial information in the bottom-order swath spray rate information layer 504. The displayed task information includes a map of the field 202 showing the waypoints 402 of the guide path 104a to be sprayed as shown in FIG. 4.

At step 612, the controller 300 controls the sprayer 100 to spray the swath 108a along the guide path 104a in accordance with the spatial information in the bottom-order swath spray rate information layer 504. The controller 300 controls the actual spray rate of the sprayer 100 according to the spray rate field 548 in the bottom-order swath spray rate information layer 504 for each waypoint 542 along the guide path 104a.

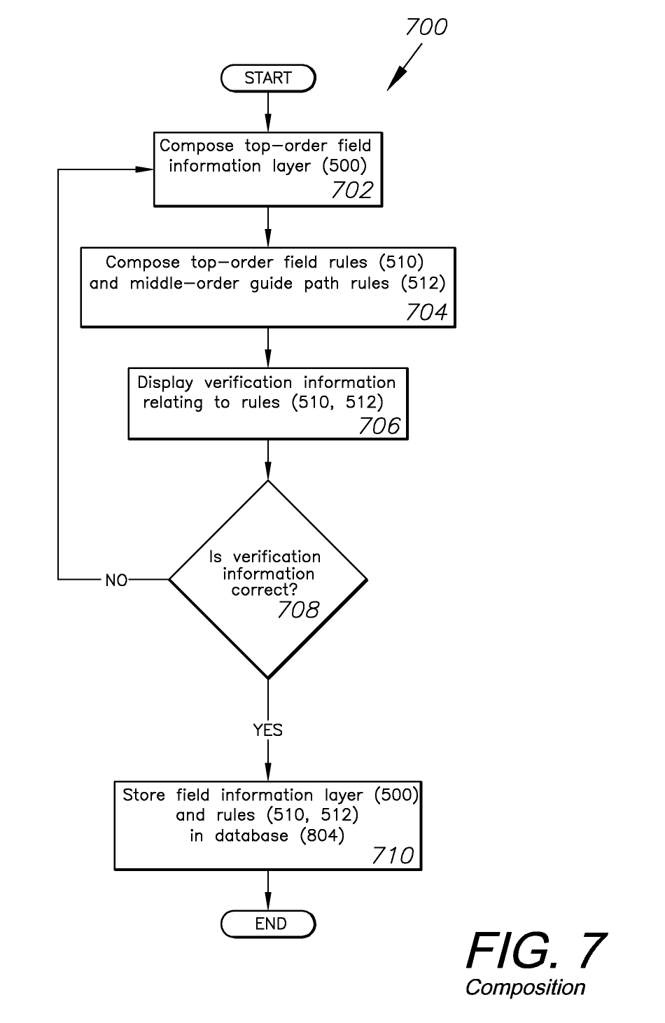

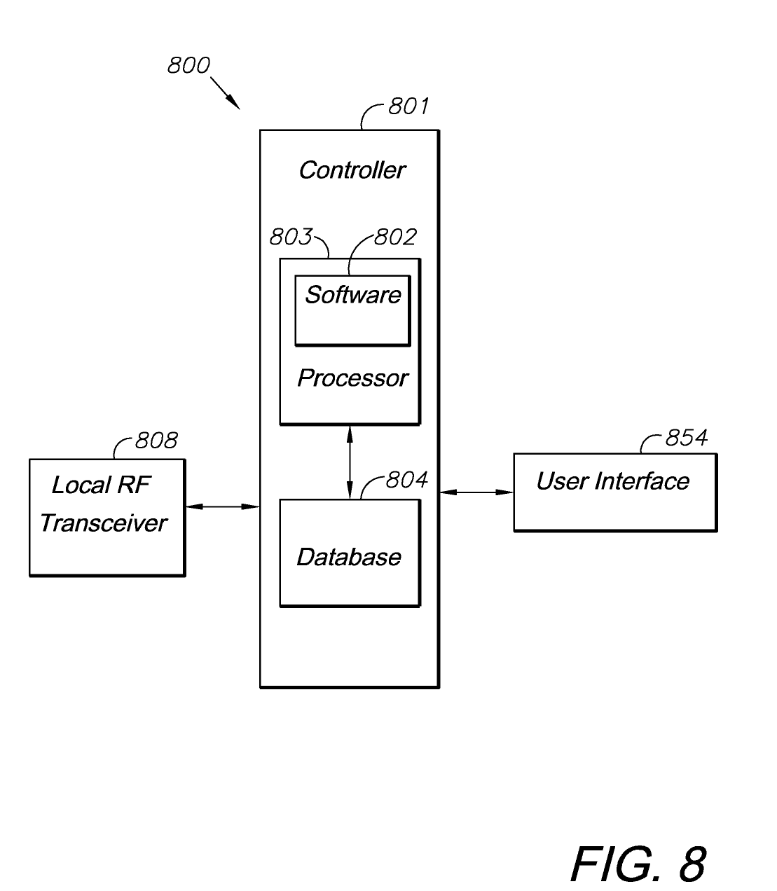

FIG. 7 shows a composition method 700 for composing the task of spraying the field 202 to be performed by at least one sprayer 100. The method 700 is performed using a control system 800 of the command center 204 shown in FIG. 8. The control system 800 has a controller 801, a local RF transceiver 808, software product (program) 802, processor 803, and a user interface 854 similar to the control system 110 previously described.

At step 702, the control system 800 receives information relating to the task of spraying the field 202. In particular, the control system 800 receives input from a command center 204 operator in the form of specification attributes relating to the geographical corner points (Lat X, Long X) and (Lat Y, Long Y) of the field 202, the endpoints of the first guide path 104 in the field 202 and the swath sprayer width 524 of each sprayer 100. In turn, the control system 800 composes the top-order field information layer 500 by respectively storing associated attributes in the task field, the first guide path endpoints field 522 and the swath spray width field 524 of the top-order field information layer 500.

At step 704, the computational device 800 receives input from a command center 204 operator in the form of further specification attributes to form the top-order field rules 510 and the middle-order field rules 512.

In both steps 702 and 704 above, the specification attributes can be entered using the user interface 854 of the control system 800 by the command center 204 operator in response to queries posed on the display of the user interface 354.

At step 706, the control system 800 displays on its electrical display verification information relating to the top-order field information layer 500 and the rules. The verification information can include maps of the field 202 shown in FIGS. 2 and 4, and provides the command center 204 operator with a check to ensure that the specification attributes have been entered correctly.

At query step 708, the command center 204 operator determines whether the verification information is correct, inputting an associated command to the control system 800. If the verification information is not correct, the method 700 returns to step 702 so that specification attributes can be re-entered by the command center 204 operator. If the verification information is correct, the method 700 proceeds to step 710.

At step 710, the control system 800 stores the composed top-order field information layer 500 and the rules 510, 512 in the database 804.

A person skilled in the art will appreciate that many embodiments and variations can be made without departing from the ambit of the present invention.

Whilst the spraying system 200 described above included only two sprayers 100a, 100b, the skilled person will understand that the system is readily scalable to include further sprayers 100 which also act as automatons.

In the preferred embodiment, the database 804 included many mirrored local versions at respective locations. In an alternative embodiment, the database 804 is instead located at a single location.

In the preferred embodiment, the local versions of the database 304 were periodically synchronized with the database 804. In an alternative embodiment, event based synchronization may be instead employed whereby synchronization of data among the versions only occurs when data in a local version of the database 304 is altered.

In compliance with the statute, the invention has been described in language more or less specific to structural or methodical features. It is to be understood that the invention is not limited to specific features shown or described since the means herein described comprises preferred forms of plating the invention into effect. The invention is, therefore, claimed in any of its forms or modifications within the proper scope of the appended claims appropriately interpreted by those skilled in the art.

Having thus described the invention, what is claimed as new and desired to be secured by Letters Patent is:

1. A method for decomposing a task to be performed by at least one vehicle assembly, the method including the steps of:
providing a higher-order information layer relating to the task and one or more rules for decomposing the higher-order information layer; and
decomposing, with a controller and at least partially, the higher-order information layer with the rules to form a lower-order information layer, the lower-order information layer relating to at least one subtask of the task.

2. A method as claimed in claim 1, wherein the information layers include spatial information relating to a space in which the vehicle assembly operates.

3. A method as claimed in claim 2, further including the step of displaying task information on a display of the vehicle assembly based upon the spatial information.

4. A method as claimed in claim 3, wherein the displayed task information includes a map.

5. A method as claimed in claim 1, further including the step of the vehicle assembly performing the subtask in space in accordance with information in the lower-order layer.

6. A method as claimed in claim 5, wherein the lower-order information layer includes a set of waypoints in the space with each waypoint associated with one or more attributes for performing the subtask.

7. A method as claimed in claim 1, wherein the rules include spatial rules relating to a space in which the vehicle assembly can perform the task.

8. A method as claimed in claim 7, wherein the vehicle assembly is an agricultural vehicle assembly, the space is a field and the task is the spraying of the field.

9. A method as claimed in claim 1 which, prior to the step of providing, further includes the step of decomposing an even higher-order information layer with other rules to form the higher-order information layer.

10. A method as claimed in claim 9, wherein the even higher-order information layer and other rules are stored in a database of the controller.

11. A method as claimed in claim 10, wherein the database is synchronized with databases of other vehicle assemblies.

12. A method as claimed in claim 1 which, prior to the step of providing a higher-order information layer, includes the step of:
composing, with a computational device, the higher-order information layer based upon input information relating to the task to be performed by the vehicle assembly.

13. A method as claimed in claim 12, further including the step of forming the rules using received input from a user, the composed higher-order information layer being based upon the received input.

14. A method as claimed in claim 13, further including the step of displaying verification information on a display of the computational device, the verification information relating to the higher-order information layer and the rules.

15. A method as claimed in claim 14, wherein the verification information includes a map.

16. A method as claimed in claim 13, further including the step of storing the composed higher-order information and the rules in a database, the database synchronized with a database of the vehicle assembly.

17. A controller for decomposing a task to be performed by at least one vehicle assembly, the controller configured to:
decompose with rules and at least partially, a higher-order information layer relating to the task to form a lower-order information layer, the lower-order information layer relating to at least one subtask of the task.

18. A method for composing a task to be performed by at least one vehicle assembly, the method including the steps of:
composing, with a computational device, a higher order information layer relating to the task; and
forming one or more rules for at least partially decomposing the higher-order information to form a lower-order information layer, the lower-order information layer relating to at least one subtask of the task.

19. A method as claimed in claim 18, further including the step of displaying verification information on a display of the computational device, the verification information relating to the higher-order information layer and the rules.

20. A method as claimed in claim 19, wherein the verification information includes a map.

21. A method as claimed in claim 18, further including the step of storing the composed higher-order information and the rules in a database, the database synchronized with a database of the vehicle assembly.

22. A method as claimed in claim 18, wherein the composed higher order information layer and formed rules are based upon user-specified attributes.

23. A computational device for composing a task to be performed by at least one vehicle assembly, the computational device configured to:
compose a higher order information layer relating to the task; and
form one or more rules for at least partially decomposing the higher-order information to form a lower-order information layer, the lower-order information layer relating to at least one subtask of the task.
